(19) United States
(12) Patent Application Publication
(10) Pub. No.: US 2007/0233757 A1
(43) Pub. Date: Oct. 4, 2007

(54) Garbage collection method and a hierarchy storage device

(75) Inventors: Yusuke Inai, Kawasaki (JP); Yasuhiro Onda, Kawasaki (JP); Fumio Yamazaki, Kawasaki (JP); Satoshi Taki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/727,180

(22) Filed: Mar. 23, 2007

(30) Foreign Application Priority Data
Mar. 30, 2006 (JP) 2006-094938
Apr. 19, 2006 (JP) 2006-115893

(51) Int. Cl. G06F 17/30

(52) U.S. Cl. 707/206

(57) ABSTRACT

The present invention relates a method and system for garbage collection of a magnetic tape, and it is an object of the present invention to provide a method and system for garbage collection of a magnetic tape, which are capable of efficiently executing a garbage collection.

A tape library device connected with a magnetic disk device. The tape library device includes at least two magnetic tape media being capable of storing data and first controller for controlling transfer information and storing information. The magnetic disc device includes a magnetic disc being capable of storing data and second controller for controlling transfer information and storing information.

### BACKGROUND OF THE INVENTION

1. Field of the Invention

The present invention relates to a method and system for garbage collection of a magnetic tape, and more particularly, it relates to a control function implemented in an information management system that utilizes a tape library device.

2. Description of the Related Art

Tape media used for an existing tape library device, when data are updated, record the updated data onto a portion that is subsequent to the data end because of the characteristics of the media. As a result, invalid data go on increasing due to the updating and, therefore, data that are recorded on the tape media need to be reconstructed on a regular schedule. The function that automatically reconstructs data is called garbage collection function.

FIG. 2 is a diagram that illustrates a reconstruction of data by means of a garbage collection function. A garbage collection is performed between an old tape medium and a new tape medium. As show in the drawing, the old tape medium contains valid data and invalid data. Here, DATA0 and DATA1 are valid data, and DATA2 and DATA3 are invalid data. The invalid data has a flag area that indicates that the data is invalid.

In this state, when the data are transferred from the old tape medium to the new tape medium, first, the valid data DATA0 and DATA1 are recorded, secondly the invalid data DATA2 and DATA3 are skipped, and the next valid data DATA4, DATA2, and DATA3 are then recorded.

In existing systems of this type, there is a known technique that a memory space is divided into a first area and a second area, wherein the first area stores objects that are newly allocated, while the second area stores old objects, and, when the first block of the first area where new objects are to be stored becomes full, the objects are allocated to the second block of the first area which is, for example, described in PCT Japanese Translation Patent Publication No. 2003-515812.

Also, there is another known technique that two central processing units are provided exclusively for garbage collection process and exclusively for normal process, respectively, so as to be able to read or write a main memory independently, and a batch-type copying garbage collection process is executed, while at the same time normal process is executed in parallel which is, for example, described in Japanese Laid-Open Patent Application No. 05-81120.

While garbage collection process is being executed, it is performed as a series of processes from the reading of data to be reconstructed to the writing of data to another tape medium, so that two drives of the tape library device are being used dominantly. This causes other processes to be lower throughput performance and lower response performance, so that it has been required to consider a period of time when garbage collection operates.

FIG. 3 is a diagram that illustrates a garbage collection of a tape library device. In the drawing, the reference numerals 1 denote drives that write into or read out from a tape medium. In the drawing, it shows the case where four drives that consist of a zero drive to a third drive are provided. The reference numeral 2 denotes a tape medium that is driven by the first drive. The reference numeral 3 denotes a tape medium that is driven by the second drive.

With regard to data that are recorded on the tape medium 2, when taking the case shown in FIG. 2 for instance, first DATA0 and DATA1 are recorded on the tape medium-3, secondly invalid data DATA2 and DATA3 are skipped, and then the next data DATA4 is recorded. In this case, after the data DATA0 and DATA1 have been recorded, the tape medium 2 is rewound. Then, the tape medium is newly wound from the position 0 and, when it reaches the position of the data DATA4, the data DATA4 is then recorded on the tape medium 3. The reason why it is thus rewound is that the positioning of a tape medium cannot be performed accurately.

Thus, in the existing system, when valid data are copied from a tape medium that contains invalid data areas to be recorded onto another tape medium, the tape must be rewound every time a data area that contains an invalid data is found. Therefore, there is a problem that the process takes a long time.

Thus, in the existing system, the reading of data to be reconstructed requires a rewinding process of the tape because reading portions are dispersed, whereas the writing to another tape medium does not require a rewinding process of the tape because it is performed sequentially. As a result, while a rewinding process is being performed in the process of reading of data to be reconstructed, a tape drive that is being used for writing to another tape medium will have a waiting time.

### SUMMARY OF THE INVENTION

The present invention addresses such a problem, and it is an object of the present invention to provide a method and system for garbage collection of a magnetic tape, by which a garbage collection is efficiently performed.

According to a preferred embodiment of the present invention, a garbage collection method controls a hierarchy storage device including a tape library device and a magnetic disc device. The tape library device includes at least two magnetic tape media being capable of storing data. The magnetic disc device is capable of storing data. The garbage collection method comprises: transferring information of one of the magnetic tape media to the magnetic disc device; storing information form the tape library device in the magnetic disc device; transferring stored information in the magnetic disc device to the tape library device; organizing information transferred between the tape library device and the magnetic disc device by discarding invalid data and sorting a stream of valid data in the information; and storing the organized valid data information at the another of the magnetic tape media.

### BRIEF DESCRIPTION OF THE DRAWINGS

FIG. 1 is a schematic diagram that shows an example embodiment of the present invention.

FIG. 2 is a diagram that illustrates a reconstruction of data by means of a garbage collection function.

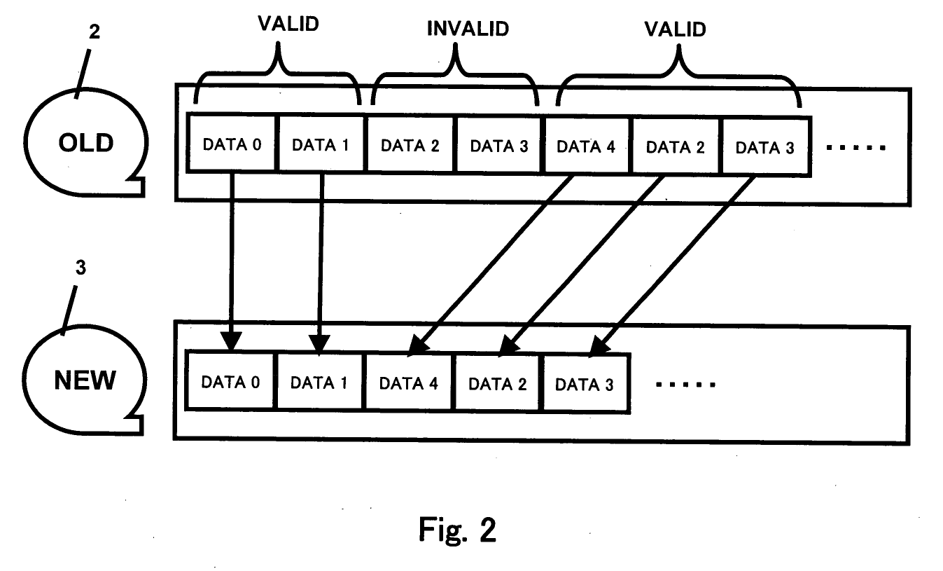

FIG. 3 is a diagram that illustrates a garbage collection of a tape library device.

### DETAILED DESCRIPTION OF THE PREFERRED EMBODIMENTS

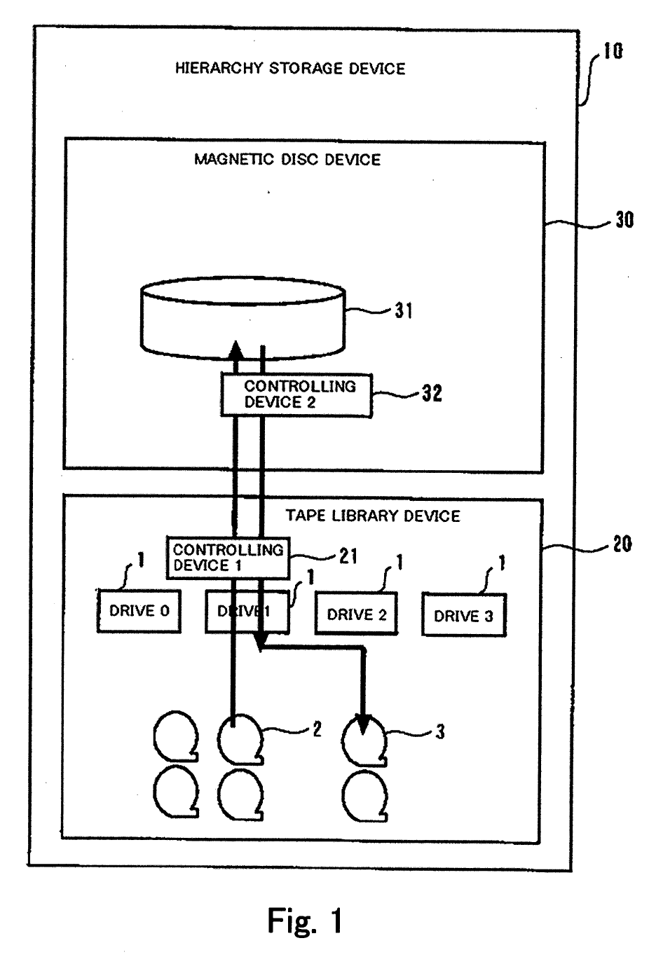

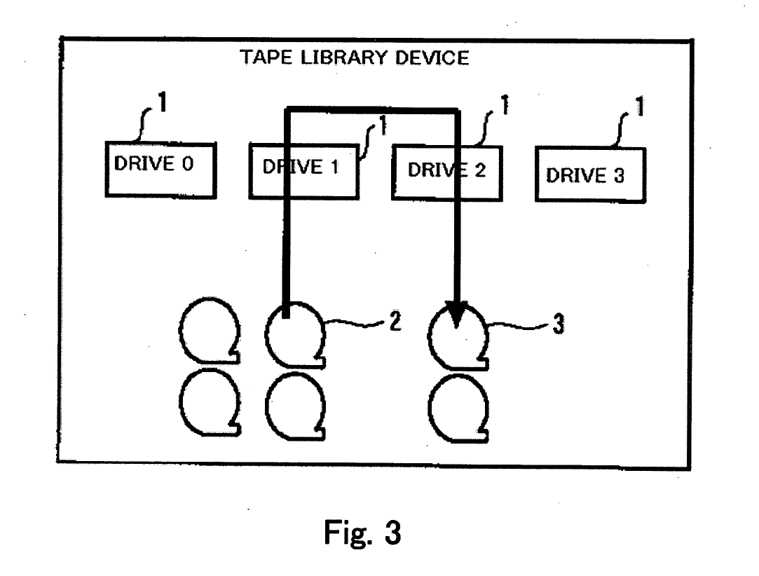

An example embodiment according to the present invention will be further illustrated below with reference to the drawings. FIG. 1 is a schematic diagram that shows an example embodiment of the present invention. The same reference numerals denote the same components as those in FIG. 3. In the drawing, the reference numeral 20 denotes a tape library device, and the reference numeral 30 denotes a magnetic disk device. These tape library device 20 and magnetic disk device 30 form a hierarchical storage device 10.

In the tape library device 20, the reference numerals 1 denote drives that drive tape media. The drawing shows a case where four drives that consist of a drive-0 to a drive-3 are installed. However, the number of drives is not limited to it. Arbitrary number of drives is applicable.

When only valid data are transferred from the tape library device side:

The reference numeral 2 denotes a tape medium on which valid data and invalid data are recorded, and the reference numeral 3 denotes a tape medium onto which all reconstruction data are to be written. The reference numeral 21 denotes a first controller that filters only valid data from data that are recorded on the tape medium 2 and transfers the data to the side of the magnetic disk device 30.

In the magnetic disk device 30, the reference numeral 31 denotes a magnetic disk that once stores data that are transferred from the tape library device 20. The reference numeral 32 denotes a second controller that transfers and records valid data to the new-tape medium 3, the valid data being stored on the magnetic disk 31. The tape library device 20 and the magnetic disk device 30 are configured to be able to transfer and receive data to and from each other.

Data that are recorded on the tape medium 2 are valid data and invalid data. The first controller, when transferring data to the side of the magnetic disk device 30, detects data areas whose flag area has an invalid flag. Then, the data for which an invalid flag is set are ignored. Only valid data for which no invalid flag is set are transferred to the side of the magnetic disk device 30. At the side of the magnetic disk device 30, transferred data are stored in a memory area once.

The operation when data are transferred and recorded onto the new tape medium 3 will now be described. The second controller sequentially reads data that are stored on the magnetic disk 31, and transfers the data to the side of the tape library device 20. At the side of the tape library device 20, the first controller sequentially transfers and records input data onto the tape medium 3.

When all the data are transferred from the tape library device side:

The first controller sequentially reads data that are recorded on the tape medium 2 and transfers all the data, in spite of valid data or invalid data, to the side of the magnetic disk device 30. The second controller stores transferred data on the magnetic disk 31 once.

When reconstruction data are transferred and recorded onto the new tape medium 3, flag data that are recorded in the flag area of the data area are referred to. When data that indicates invalidation of data is set for the flag, the data area is ignored. Then, only data for which no data that indicates invalidation of data is set for a flag are filtered and transferred sequentially to the side of the tape library device 20.

At the side of the tape library device 20, the first controller receives the data and sequentially records the valid data onto the tape medium 3.

As described above, the present invention provides:

1) a process for storing data that are recorded on a tape medium to a magnetic pole disk system side; and

2) a process for recording all the data to be reconstructed, which are stored at the magnetic disk device side, onto a tape medium.

According to the present invention, data that are recorded on a tape medium are transferred and recorded onto a magnetic disk device once, and only valid data may be recorded from the magnetic disk device onto a new tape medium, so that a garbage collection may be efficiently performed.

As described above in particular, according to the present invention, a garbage collection process can be executed separately as reading of data and writing of data. This can make the number of tape drives used exclusively for garbage collection be one. Thus, the rate of deterioration in the through put performance and response performance of processes other than garbage collection is reduced.

Furthermore, by storing all the data, which are to be reconstructed, at the magnetic disk device side once, though no waiting time is required for a tape drive that is used for writing reconstruction data, reconstruction data may be written onto a tape medium.

### Embodiments have Advantages Below:

(1) According to the invention, data that are recorded on a tape medium is transferred and recorded onto a magnetic disk device once, and then only valid data may be recorded from the magnetic disk device onto a new tape medium, so that a garbage collection may be efficiently performed.

(2) According to the invention, a magnetic disk device is capable of receiving only valid data from a tape library device and recording the valid data onto a new tape medium.

(3) According to the invention, a magnetic disk device is capable of receiving all the data, including invalid data, from a tape library device, organizing these data, and recording only valid data onto a new tape medium.

(4) According to the invention, data that are recorded on a tape medium are transferred and recorded onto a magnetic disk device once, and only valid data may be recorded from the magnetic disk device onto a new tape medium, so that a garbage collection may be efficiently performed.

What is claimed is:

1. A garbage collection method for controlling a hierarchy storage device including a tape library device and a magnetic disc device, the tape library device including at least two magnetic tape media being capable of storing data, the magnetic disc device being capable of storing data, the garbage collection method comprising:
transferring information of one of the magnetic tape media to the magnetic disc device;
storing information from the tape library device in the magnetic disc device;
transferring stored information in the magnetic disc device to the tape library device;
organizing information transferred between the tape library device and the magnetic disc device by discarding invalid data and sorting a stream of valid data in the information; and
storing the organized valid data information at the another of the magnetic tape media.

2. The method of claim 1, wherein the organizing transfers valid data to the magnetic disc device.

3. The method of claim 1, wherein the organizing transfers valid data and in valid data to the magnetic disc device and transfers the valid data from the disc device to the tape library device.

4. A hierarchy storage device for controlling a garbage collection, comprising:
a tape library device including at least two magnetic tape media being capable of storing data and first controller for controlling transfer information and storing information; and
a magnetic disc device including a magnetic disc being capable of storing data and second controller for controlling transfer information and-storing information;
wherein the first and the second controller organize information transferred between the tape library device and the magnetic disc device by discarding invalid data and sorting a stream of valid data in the information.

5. The hierarchy storage device of the claim 1, wherein the first controller transfers valid data to the magnetic disc device and the second controller transfers valid date to the tape library device.

6. The hierarchy storage device of the claim 1, wherein the first controller transfers valid date and in valid data to the magnetic disc device and the second controller transfers valid date to the tape library device.
